(19) United States
(12) Patent Application Publication
(10) Pub. No.: US 2022/0260760 A1
(43) Pub. Date: Aug. 18, 2022

(54) OPTICAL SYSTEM INCLUDING MICROLENSES AND LIGHT-BLOCKING STRUCTURES

(71) Applicant: 3M INNOVATIVE PROPERTIES COMPANY, St. Paul, MN (US)

(72) Inventors: Zhaohui Yang, North Oaks, MN (US); Tri D. Pham, Woodbury, MN (US); Matthew S. Stay, Bloomington, MN (US); Matthew R.D. Smith, Woodbury, MN (US); Daniel J. Theis, Mahtomedi, MN (US); Serena L. Schleusner, Roberts, WI (US); Jathan D. Edwards, Afton, MN (US)

(21) Appl. No.: 17/628,673

(22) PCT Filed: Jul. 7, 2020
(86) PCT No.: PCT/IB2020/056386

§ 371 Date: Jan. 20, 2022

Related U.S. Application Data
(60) Provisional application No. 62/877,432, filed on Jul. 23, 2019.

(51) Int. Cl. G02B 3/00; G02B 5/00

(52) U.S. Cl. CPC G02B 3/0037; G02B 5/003; G06F 3/0421; G02B 5/005; G02B 3/0075

(57) ABSTRACT

An optical system is disclosed and includes an image sensor (112), a plurality of microlenses (142), at least one microlens of the plurality of microlenses defining a microlens height and a microlens diameter. The optical system also includes a plurality of light-blocking structures (146), at least one light-blocking structure of the plurality of light-blocking structures defining a light-blocking structure height and a light-blocking structure width. An aperture array (134) includes a plurality of apertures (138), each aperture being aligned with a microlens of the plurality of microlenses, and the microlenses and the light-blocking structures extend from the aperture array toward the image sensor. The systems, structures and features disclosed herein can improve a signal-to-noise ratio when detecting images, via the optical sensor, from behind a display.

### BACKGROUND

Optical systems can include a plurality of microlenses and apertures to focus and transmit light. Various geometric arrangements of optical elements can facilitate the selective transmission of light through the microlenses based upon certain angular ranges.

### SUMMARY

In some aspects, an optical system is disclosed. The optical system can include an image sensor, a plurality of microlenses, at least one microlens of the plurality of microlenses defining a microlens height and a microlens diameter and a plurality of light-blocking structures, at least one light-blocking structure of the plurality of light-blocking structures defining a light-blocking structure height and a light-blocking structure width. An aperture array can also be included and can define a plurality of apertures, each aperture can be aligned with a microlens of the plurality of microlenses. The microlenses and the light-blocking structures can extend from the aperture array away from the image sensor.

In some aspects, an optical system is disclosed. The optical system can include a display, a plurality of microlenses, at least one microlens of the plurality of microlenses defining a microlens height and a microlens diameter and a plurality of light-blocking structures, at least one light-blocking structure of the plurality of light-blocking structures defining a light-blocking structure height and a light-blocking structure width. The optical system can also include an aperture array defining a plurality of apertures, at least one aperture being aligned with a microlens of the plurality of microlenses. The display can include relatively transmissive regions and relatively non-transmissive regions, at least one relatively transmissive region can be substantially aligned with at least one microlens and at least one relatively non-transmissive region can be aligned with at least one blocking structure.

The systems, structures and features disclosed herein can improve a signal-to-noise ratio when detecting images, via the optical sensor, from behind a display. Other benefits and uses are also foreseen.

### BRIEF DESCRIPTION OF THE DRAWINGS

FIG. 1 is a side elevation view of an optical system, according to exemplary embodiments of the present disclosure.

FIG. 2 is a side elevation view of an exemplary optical element including lands, according to exemplary embodiments of the present disclosure.

FIG. 3 is a side elevation view of an exemplary optical element including gaps, according to exemplary embodiments of the present disclosure.

FIG. 4 is a side elevation view of an exemplary optical element including lands and gaps, according to exemplary embodiments of the present disclosure.

FIG. 5 is a side elevation view of an exemplary optical element including lands and gaps, and further showing portions of the lands, gaps and light-blocking structure including a light-blocking material, according to exemplary embodiments of the present disclosure.

FIGS. 6a and 6b are side elevation views of a light-blocking structure, according to exemplary embodiments of the present disclosure.

FIG. 7 is a side elevation view of an optical system, different from that shown in FIG. 1, according to exemplary embodiments of the present disclosure.

FIGS. 8a-8c are side elevation views showing various light rays interacting with elements of various optical layers, according to exemplary embodiments of the present disclosure.

FIG. 9 is a side elevation view of an exemplary optical layer and optical sensor according to exemplary embodiments of the present disclosure.

FIGS. 10a and 10b are side elevation views of blocking structures contacting or supporting, directly or via an adhesive, a display and an optical image sensor respectively, according to exemplary embodiments of the present disclosure.

FIG. 11 is a side elevation view of an optical system including a display having relatively transmissive and relatively non-transmissive regions, according to exemplary embodiments of the present disclosure.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

It may be desirable to use an optical device to transmit light to an optical sensor. To prevent certain light rays from passing through apertures disposed at a particular angle from a reflection source, various structures, materials and geometries can be employed that also allow the passage of certain other light rays through apertures disposed at another angle from the reflection source.

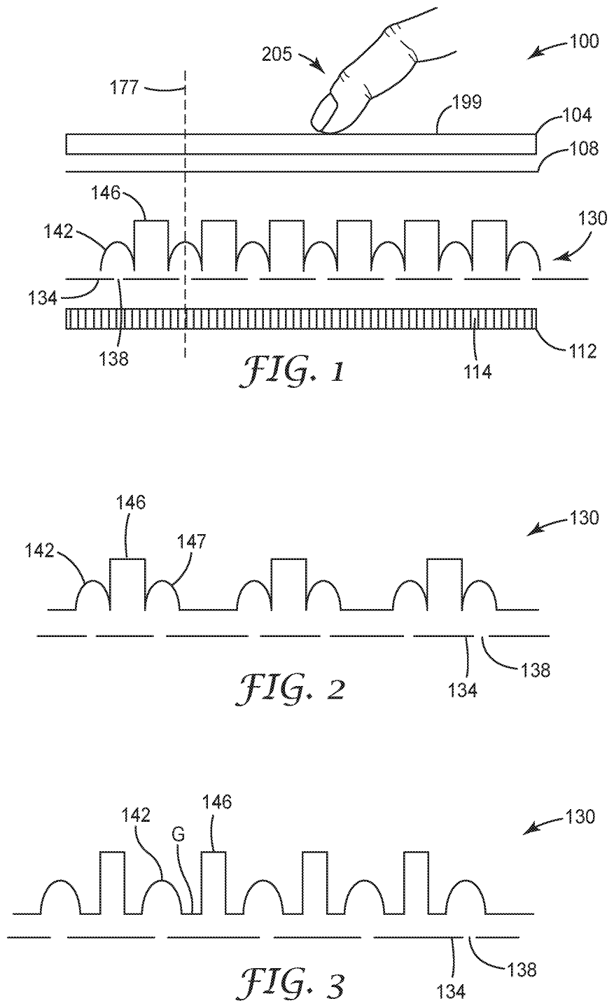

FIG. 1 is a side elevation view of an exemplary optical system 100. The optical system 100 can include a display 104, an optical filter 108 and an optical sensor 112. In some embodiments, the display 104 can include an emissive display, such as an Organic Light-Emitting Diode (OLED) or a micro-LED (Light-Emitting Diode), or a transmissive display such as a Liquid Crystal Display (LCD).

The optical sensor 112 can be divided into a plurality of light-gathering photosensitive picture elements, or pixels 114. optical sensor 112 can include a charge-coupled device, a complementary-metal-oxide semiconductor or can employ any other light-sensing sensor technology or a combination of light-sensing technologies. Additionally, the optical sensor 112 can include one or more photosensors, organic photosensors, photodiodes and/or organic photodiodes.

The optical system 100 can also include an optical layer 130. In some embodiments, the optical layer 130 is disposed substantially between the optical sensor 112 and the display 104. The optical layer 130 can include an aperture array 134, one or more microlenses 142 and one or more blocking structures, or light-blocking structures 146. The aperture array 134 can define one or more apertures 138, through which at least some light incident on the aperture array 134 can pass. The apertures 138 can form an orthogonal pattern or a non-orthogonal pattern in the aperture array 134.

In some embodiments, the optical sensor 112 and/or the optical layer 130 is flexible. Such a flexible optical sensor 112 or optical layer 130 can have properties of being bendable without cracking. Such a flexible optical sensor 112 or optical layer 130 can also be capable of being formed into a roll. In some embodiments, the flexible optical sensor 112 or optical layer 130 can be bent around a roll core with a radius of curvature of 7.6 centimeters (cm) (3 inches), 6.4 cm (2.5 inches), 5 cm (2 inches), 3.8 cm (1.5 inches), 2.5 cm (1 inch), 1.9 cm (¾ inch), 1.3 cm (½ inch) or 0.635 cm (¼ inch).

At least one aperture 138 can be registered with, or aligned with, one of the microlenses 142. In some embodiments, each aperture 138 is registered with a microlens 142. In some embodiments, at least one aperture 138 is disposed such that the aperture 138 and a microlens 142 are each substantially centered on a line 177 orthogonal to the optical layer 130, optical sensor 112 and/or display 104.

The microlenses 142, blocking structures 146 and lands 147 (exemplarily shown in FIG. 2) can all be formed from a common material. This material can be a polymeric material having certain thermal or rheological properties. For example, the material may have a sufficiently high glass transition temperature to keep its form or rigidity during processing. In some embodiments, the material may be microreplicated through a continuous cast and cure microreplication process. Such a material may be curable by the application of radiation (such as heat or ultraviolet light).

In some embodiments, the aperture array 134 includes an opaque layer of any suitable material, such as a plastic, metal, resin, polymer or composite material, any of which can be substantially black or have a dark shade or color. The aperture array 134 may be perforated while attached to the microlenses 142, blocking structures 146 and/or lands 147, and thus an aperture array 134 material and thickness may be chosen such that the aperture array 134 may be perforated without requiring physical puncturing. In some embodiments, this is performed by a focused beam of radiation, such as a laser. Such a focused beam of radiation may burn a hole through the aperture array 134, thus forming the apertures 138. In some embodiments, the aperture array 134 includes a multilayer optical reflector. Multilayer optical reflectors are typically formed from a series of alternating polymers, one being birefringent and one being isotropic. In some embodiments, the in-plane indices of consecutive alternative layers have some mismatch, which causes light of a certain wavelength to be reflected through constructive interference.

In some embodiments, a polymer resin can be coated on the microlenses 142 and surface tension can be employed to clear said resin from at least portions of the microlenses 142. The polymer resin can be black and further can include or define the light-blocking material 191

In some embodiments, as best illustrated in FIG. 2, a land 147 can be disposed between adjacent microlenses 142. The land 147 can include substantially flat areas, or can assume various shapes or contours. Blocking structures 146 can be disposed between some pairs of microlenses 142, while lands 147 can be disposed between other pairs of microlenses 142. In some embodiments, lands 147 and blocking structures 146 can alternate between sequential microlenses 142, such that a land 147 is disposed between exemplary first and second successive microlenses 142 and a blocking structure 146 is disposed between exemplary second and third successive microlenses 142. In some embodiments, successive lands 147 can be disposed between sequential microlenses 142, such that a land 147 is disposed between exemplary first and second successive microlenses 142 and a land 147 is disposed between exemplary second and third successive microlenses 142. In some embodiments, successive blocking structures 146 can be disposed between sequential microlenses 142, such that a blocking structure 146 is disposed between exemplary first and second successive microlenses 142 and a blocking structure 146 is disposed between exemplary second and third successive microlenses 142. In some embodiments, there are about, or less than, 1/10,000, 1/1,000, 1/100, 1/50, 1/20, 1/10, ¼, ⅓, ½, ⅔ or ¾ the number of blocking structures 146 as lands 147 as counted along 100 sequential microlenses 142. In some embodiments, there are about, or less than, 1/10,000, 1/1,000, 1/100, 1/50, 1/20, 1/10, ¼, ⅓, ½, ⅔ or ¾ the number of lands 147 as blocking structures 146 as counted along 100 sequential microlenses 142.

In some embodiments, as best illustrated in FIG. 3, a gap G can be disposed between a microlens 142 and a blocking structure 146 and can define a gap length GL. Further, the gap G can be disposed on opposed sides of a blocking structure 146, and the blocking structure 146 and the gaps G disposed on opposed sides of the blocking structure 146 can all be disposed between sequential microlenses 142. In some embodiments, gaps G on opposed sides of the blocking structure 146 can be substantially the same size, or length. In some embodiments, as shown in FIG. 3, a pair of sequential microlenses 142 can have a blocking structure 146, and gaps G disposed on opposed sides of the blocking structure 146, disposed therebetween. In some embodiments, as shown in FIG. 3, some pairs of sequential microlenses 142 can have a blocking structure 146, and gaps G disposed on opposed sides of the blocking structure 146, disposed therebetween, while other pairs of sequential microlenses 142 include a land 147 or a blocking structure 146 therebetween.

In some embodiments, there are about, or less than, 1/10,000, 1/1,000, 1/100, 1/50, 1/20, 1/10, ¼, ⅓, ½, ⅔ or ¾ the number of pairs of sequential microlenses 142 having a blocking structure 146, and gaps G disposed on opposed sides of the blocking structure 146, disposed therebetween as pairs of sequential microlenses 142 including a land 147 or a blocking structure 146 therebetween as counted along 100 sequential microlenses 142. In some embodiments, there are about, or less than, 1/10,000, 1/1,000, 1/100, 1/50, 1/20, 1/10, ¼, ⅓, ½, ⅔ or ¾ the number of pairs of sequential microlenses 142 including a land 147 or a blocking structure 146 therebetween as pairs of sequential microlenses 142 having a blocking structure 146, and gaps G disposed on opposed sides of the blocking structure 146, disposed therebetween as counted along 100 sequential microlenses 142.

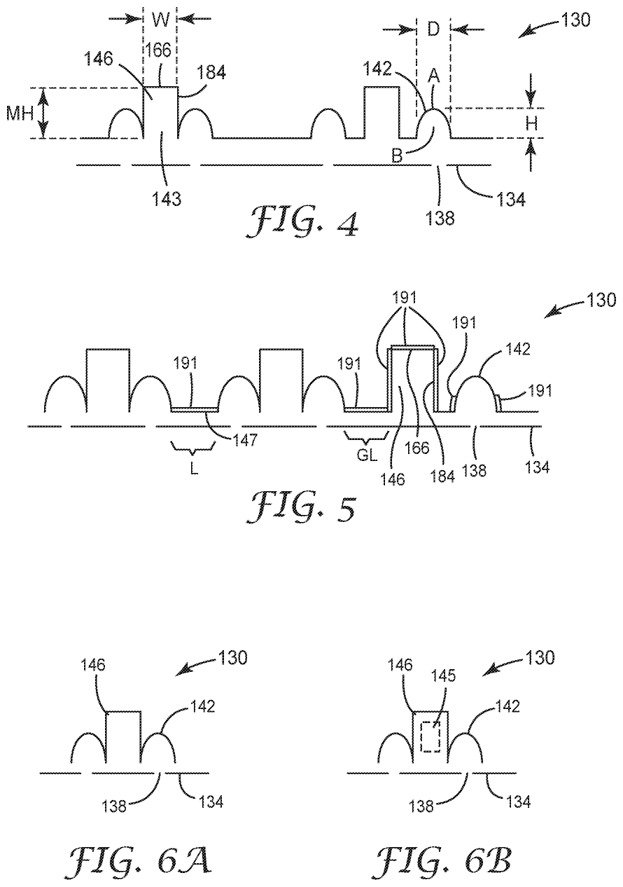

As exemplarily illustrated in FIG. 4, at least one microlens 142 defines a microlens diameter D and a microlens height H. While D can be used to indicate a diameter across a circular, or substantially circular, microlens 142, it is to be understood that D can be used to indicate a distance across a microlens 142 having any shape, a distance across a microlens 142 as measured along the shortest distance between gaps G, lands 147 or blocking structures 146 on opposed sides of the microlens 142, or an average of all possible distances across the microlens 142. The microlens height H can be used to indicate a height from a base B of the microlens 142 to an apex A of the microlens 142. Base B can be defined as a spatial point equidistant from opposed microlens 142 sides adjacent lands 147, gaps G or blocking structures 146. The microlenses 142 can each have substantially the same shape (for example, spherical or aspherical), diameter D, height H, size and/or aspect ratio (ratio of height H to diameter D).

At least one blocking structure 146 defines a blocking structure height MH and a blocking structure width W. The blocking structure height MH can be used to indicate a height from a blocking structure base 143 to a blocking structure distal surface 166. Blocking structure base 143 can be defined as a spatial point equidistant from opposed blocking structure 146 sides adjacent lands 147, gaps G or microlenses 142, and further disposed at an opposed end of the blocking structure 146 from the distal surface 166. The blocking structures 146 can each have substantially the same shape (for example, a cylinder or a rectangular prism or solid, or a shape having a constant or non-constant polygonal cross section), size, height MH, width W and/or aspect ratio (ratio of height MH to width W). It is to be understood that W can be used to indicate an overall distance across a blocking structure 146, as taken perpendicularly to line 177 or perpendicularly to the blocking structure height MH, having any shape, between sequential microlenses 142, a distance across a blocking structure 146 as measured along the shortest distance between gaps G, lands 147 or microlenses 142 on opposed sides of the blocking structure 146, or an average of all possible distances across the blocking structure 146.

In some embodiments, a microlens height H of one or more microlenses 142 is greater than a blocking structure height MH of one or more blocking structures 146. In some embodiments, one or more blocking structures 146 has a blocking structure height MH of about 10%, 20%, 30%, 40%, 50%, 60%, 70%, 80% or 90% of a microlens height H of one or more microlenses 142. In some embodiments, a microlens height H of a microlens 142 is greater than a blocking structure height MH of a blocking structure 146 adjacent the microlens 142. In some embodiments, a blocking structure 146 has a blocking structure height MH of about 10%, 20%, 30%, 40%, 50%, 60%, 70%, 80% or 90% of a microlens height H of a microlens 142 adjacent the blocking structure 146.

In some embodiments, a microlens height H of one or more microlenses 142 is less than a blocking structure height MH of one or more blocking structures 146. In some embodiments, one or more microlenses 142 has a microlens height H of about 10%, 20%, 30%, 40%, 50%, 60%, 70%, 80% or 90% of a blocking structure height MH of one or more blocking structures 146. In some embodiments, a microlens height H of a microlens 142 is less than a blocking structure height MH of a blocking structure 146 adjacent the microlens 142. In some embodiments, a microlens 142 has a microlens height H of about 10%, 20%, 30%, 40%, 50%, 60%, 70%, 80% or 90% of a blocking structure height MH of a blocking structure 146 adjacent the microlens 142.

In some embodiments, a microlens height H of one or more microlenses 142 is about equal to a blocking structure height MH of one or more blocking structures 146. In some embodiments, a microlens height H of a microlens 142 is about equal to a blocking structure height MH of a blocking structure 146 adjacent the microlens 142.

It is to be understood that while the above paragraphs disclose possible relationships between blocking structure height MH and microlens height H, the blocking structure height MH can be related to one or more of the microlens diameter D, structure width W, gap length GL and land length L in the same ways as the disclosed possible relationships between blocking structure height MH and microlens height H.

In some embodiments, a microlens diameter D of one or more microlenses 142 is greater than a blocking structure width W of one or more blocking structures 146. In some embodiments, one or more blocking structures 146 has a blocking structure width W of about 10%, 20%, 30%, 40%, 50%, 60%, 70%, 80% or 90% of a microlens diameter D of one or more microlenses 142. In some embodiments, a microlens diameter D of a microlens 142 is greater than a blocking structure width W of a blocking structure 146 adjacent the microlens 142. In some embodiments, a blocking structure 146 has a blocking structure width W of about 10%, 20%, 30%, 40%, 50%, 60%, 70%, 80% or 90% of a microlens diameter D of a microlens 142 adjacent the blocking structure 146.

In some embodiments, a microlens diameter D of one or more microlenses 142 is less than a blocking structure width W of one or more blocking structures 146. In some embodiments, one or more microlenses 142 has a microlens diameter D of about 10%, 20%, 30%, 40%, 50%, 60%, 70%, 80% or 90% of a blocking structure width W of one or more blocking structures 146. In some embodiments, a microlens diameter D of a microlens 142 is less than a blocking structure width W of a blocking structure 146 adjacent the microlens 142. In some embodiments, a microlens 142 has a microlens diameter D of about 10%, 20%, 30%, 40%, 50%, 60%, 70%, 80% or 90% of a blocking structure width W of a blocking structure 146 adjacent the microlens 142.

In some embodiments, a microlens diameter D of one or more microlenses 142 is about equal to a blocking structure width W of one or more blocking structures 146. In some embodiments, a microlens diameter D of a microlens 142 is about equal to a blocking structure width W of a blocking structure 146 adjacent the microlens 142.

It is to be understood that while the above paragraphs disclose possible relationships between blocking structure width W and microlens diameter D, the blocking structure width W can be related to one or more of the microlens height H, gap length GL and land length L in the same ways as the disclosed possible relationships between blocking structure width W and microlens diameter D.

In various embodiments H can be less than or equal to 10, 50, 100, 200 or 500 micrometers. In various embodiments, MH can be less than or equal to 100, 200, 300, 400, 500 or 1000 micrometers. In various embodiments, W can be less than or equal to 10, 50, 100, 200 or 500 micrometers. In various embodiments, D can be less than or equal to 100, 300, 500, 700 or 1000 micrometers. In various embodiments, GL can be less than or equal to 100, 500, 1000, 2000 or 5000 micrometers. In some embodiments, W is less than, or less than or equal to, a lens pitch, which can be a shortest distance measure between apexes A of successive microlenses 142.

In addition to, or in place of, the aperture array 134, portions of the optical layer 130 can include a light blocking material 191. One or both of the aperture array 134 and light blocking material 191 can, in various embodiments, absorb light, reflect light or absorb and reflect light. In some embodiments, the transmission in a desired wavelength range is low, in some cases less than 10%. In some embodiments, transmission in the visible range is less than 10%. In some embodiments, transmission in the near infrared may be less than 10%. In some embodiments, transmission in the visible and near infrared ranges may be less than 10%. Transmission percentage in a wavelength range may be calculated by dividing the total light in the wavelength range that is transmitted by the total incident light in the wavelength range.

In some embodiments, as exemplarily shown in FIG. 5, one or more of the blocking structure side surface 184 and distal surface 166 can include, or be at least partially covered with, the light blocking material 191. In some embodiments, as exemplarily shown in FIG. 5, one or more lands 147 can include, or be at least partially covered with, the light blocking material 191. In some embodiments, as exemplarily shown in FIG. 5, one or more gaps G can include, or be at least partially covered with, the light blocking material 191. In some embodiments, portions of one or more microlenses 142 can include, or be partially covered with, the light blocking material 191.

As described above, the blocking structure 146 can have a height MH and a width W. The blocking structure 146 can have any shape, such as that of a cylinder, rectangular prism, frustum or any other geometric or organic shape. At least one blocking structure 146 can define a blocking structure side surface 184, disposed substantially between distal surface 166 and blocking structure base 143. In some embodiments, the blocking structure side surface 184 is substantially perpendicular to one or both of the blocking structure base 143 and blocking structure distal surface 166.

It is also to be understood that the optical layer 130 can be devoid of blocking structures 146, and can include only microlenses 142 and lands 147. The microlenses 142 and/or lands 147 can include the light blocking material 191. In some embodiments, the light-blocking material 191 can cover both lands 147 and microlenses 142, but the thickness of the light-blocking material 191 disposed on or near the microlenses can be thinner (thus having a relatively greater light transmission) than the light blocking material disposed on or near the lands 147 (thus having a relatively lower light transmission).

In some embodiments, as best illustrated in FIG. 6a, the blocking structure 146 is substantially homogenous, wherein the blocking structure 146 is formed from a single material substantially free of voids or cavities. In some embodiments, as best illustrated in FIG. 6b, the blocking structure 146 includes at least one cavity 145, wherein the cavity 145 includes a material having different properties from the other portions of the blocking structure 146. In some embodiments, the cavity can include a gas such as air or nitrogen, a liquid or a solid different from other portions of the blocking structure 146.

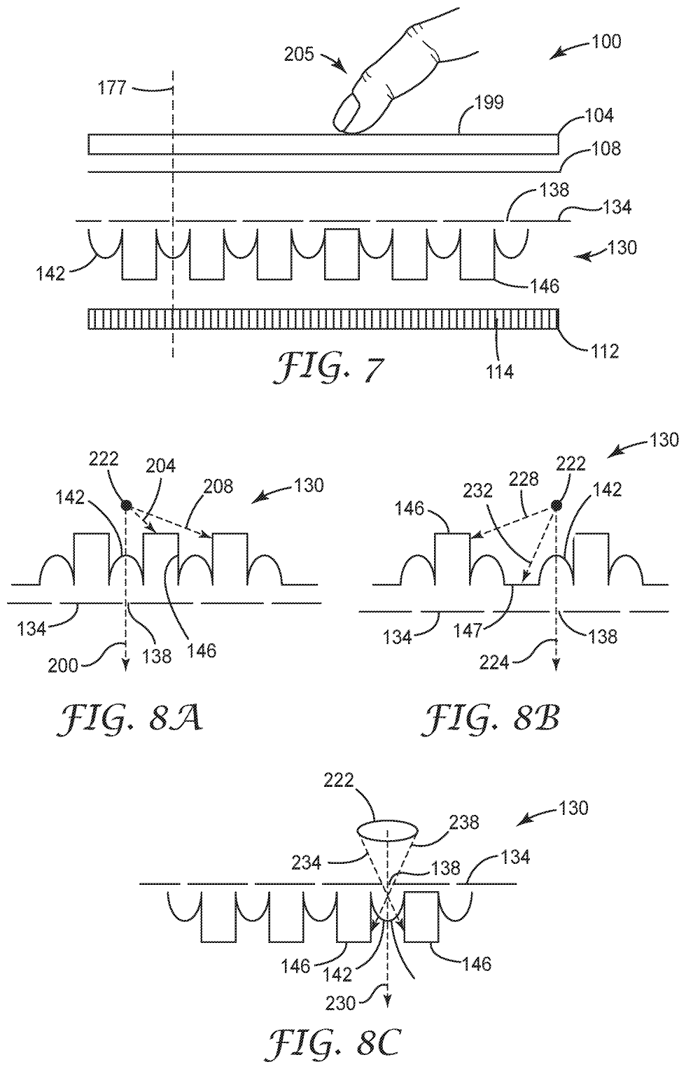

FIG. 7 illustrates an embodiment of the optical system where the optical layer 130 is inverted relative to the embodiment shown in FIG. 1. In particular, FIG. 7 illustrates an optical layer 130 where microlenses 142 and blocking structures 146 extend toward the optical sensor 112, or from the aperture array 134 toward the optical sensor 112. FIG. 7 also illustrates an embodiment where the blocking structure distal surface 166 represents a portion of the blocking structure 146 nearest to the optical sensor 112 and the microlens apex A represents a portion of the microlens 142 nearest to the optical sensor 112. In contrast, FIG. 1 illustrates an embodiment where microlenses 142 and blocking structures 146 extend away from the optical sensor 112, or from the aperture array 134 away from the optical sensor 112. FIG. 1 also illustrates an embodiment where the blocking structure distal surface 166 represents a portion of the blocking structure 146 farthest from the optical sensor 112 and the microlens apex A represents a portion of the microlens 142 farthest from the optical sensor 112. Additionally, it is to be understood that an embodiment where microlenses 142 and blocking structures 146 extend toward the optical sensor 112, such as that exemplarily illustrated in FIG. 7, can include any embodiment, feature and/or relationship as previously disclosed in the context of an embodiment where microlenses 142 and blocking structures 146 extend away from the optical sensor 112, as described above in the contest of FIGS. 1-6b.

In some embodiments, light from the display 104 (or a backlight, not shown) can travel toward an outer surface 199 of the optical system 100. An object, such as a user's finger 205, can be placed in contact with, adjacent or proximate the outer surface 199, reflects a portion of the light from the display 104, forming a source 222 which can be a reflective, transmissive or emissive source. This reflected light then travels through the display 104 toward the optical layer 130. In some embodiments, the source 222 can be disposed away from, or not in contact with, the outer surface 199, such as an object or a person disposed remotely from the outer surface 199.

As exemplarily illustrated in FIG. 8a, light ray 200 can enter the microlens 142 and subsequently pass through the aperture 138 en route to the optical sensor 112 (not shown). In contrast, light rays 204 and 208 are substantially blocked and/or reflected by blocking structures 146. As exemplarily illustrated in FIG. 8b, light ray 224 can enter the microlens 142 and subsequently pass through the aperture 138 en route to the optical sensor 112 (not shown). In contrast, light rays 228 and 232 are substantially blocked and/or reflected by blocking structure 146 and land L. As exemplarily illustrated in FIG. 8c, light ray 230 can enter the aperture 138 and subsequently pass through microlens 142 en route to the optical sensor 112 (not shown). In contrast, light rays 234 and 238 are substantially blocked and/or reflected by blocking structure 146. Thus, through the disclosed embodiments, accuracy and resolution of the optical sensor 112 can be improved by selectively blocking and passing various light rays according to angular and positional relationships of the reflection source (such as the finger 205), apertures 138, microlenses 142, blocking structures 146 and lands 147, among other features.

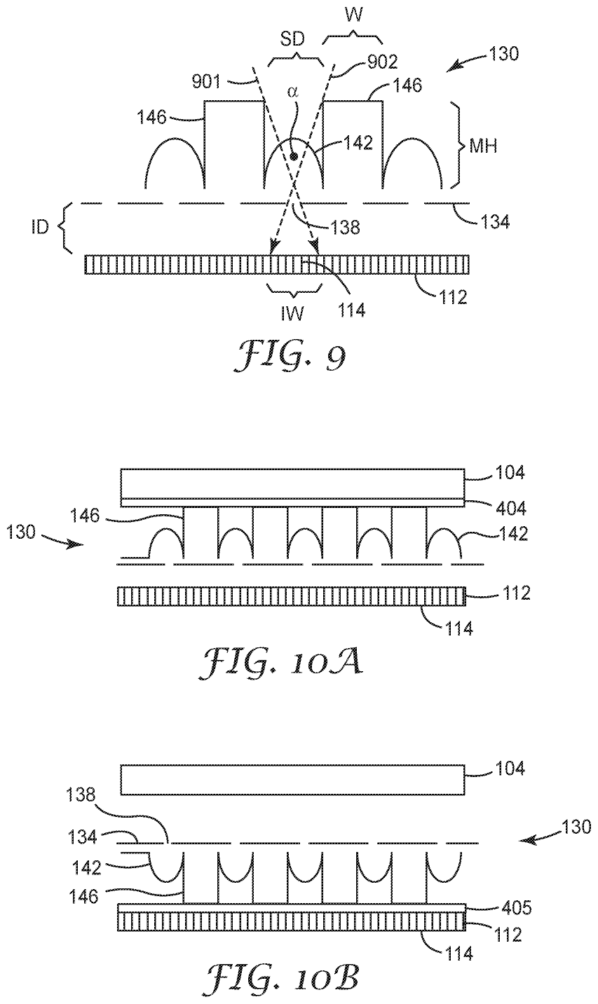

FIG. 9 is a side elevation view of an exemplary embodiment of the optical layer 130 and the optical sensor 112. In particular, blocking structure width W and blocking structure height MH are illustrated. An image width IW, taken along the optical sensor 112 is also shown, along with an image distance ID, which indicates a distance between the optical sensor 112 and the aperture array 134. A distance between successive light blocking structures SD is also shown. Due to the blocking nature of the blocking structures 146, as described above, light rays 901 and 902 represent the extreme angles allowed by the blocking members 146 and the aperture 138. In other words, light rays 901 and 902 form an angle α therebetween, a being a largest angle formable due to the construction of the optical layer 130. In some embodiments, MH>ID/(IW*SD). In some embodiments, 0.5*MH>ID/(IW*SD). In some embodiments, 0.4*MH>ID/(IW*SD). In some embodiments, 0.3*MH>ID/(IW*SD). In some embodiments, 0.2*MH>ID/(IW*SD). In some embodiments, 0.1*MH>ID/(IW*SD). In some embodiments, 0.05*MH>ID/(IW*SD).

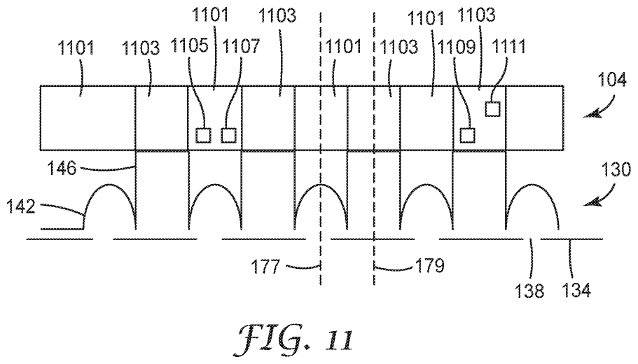

Turning to FIG. 10a, one or more light blocking structures 146 can serve as an attachment structure between the optical layer 130 and the display 104. In some embodiments, the light blocking structure 146 can mechanically attach to the display 104 or an adhesive 404 can be disposed therebetween and can attach, be joined to or adhered to at least one of the light blocking structures 146 and the display 104. Turning to FIG. 10a, one or more light blocking structures 146 can serve as an attachment structure between the optical layer 130 and the optical sensor 112. In some embodiments, the light blocking structure 146 can mechanically attach to the optical sensor 112 or an adhesive 405 can be disposed therebetween and can attach, be joined to or adhered to one or more of the light blocking structures 146 and the optical sensor 112. One or both of the adhesives 404, 405 can be an optically clear adhesive (e.g., an adhesive having a haze as determined by the ASTM D1003-13 standard, for example, of less than 5%, or less than 2%, and a luminous transmittance as determined by the ASTM D1003-13 standard, for example, of at least 80% or at least 90%). In some embodiments, one or both of the adhesives 404, 405 can include pressure-sensitive adhesives, UV-curable adhesives and/or polyvinyl alcohol-type adhesives.

FIG. 11 illustrates an embodiment of a display 104 having relatively transmissive regions 1101 and relatively non-transmissive regions 1103. The relatively non-transmissive regions 1103 can, in some embodiments, transmit about 10%, 20%, 30%, 40%, 50%, 60%, 70%, 80% or 90% of light incident on the display 104 as transmitted by the relatively transmissive regions 1103. In some embodiments, at least some relatively transmissive regions 1101 can be substantially aligned with at least some of the microlenses 142 and at least some relatively non-transmissive regions 1103 can be aligned with at least some of the blocking structures 146, lands 147 or gaps G. In some embodiments, at least some relatively transmissive regions 1101 and at least some of the microlenses 142 are each substantially centered on a line 177 orthogonal to the optical layer 130, optical sensor 112 and/or display 104. In some embodiments, at least some relatively non-transmissive regions 1103 and at least some of the blocking structures 146, lands 147 or gaps G are each substantially centered on a line 179 orthogonal to the optical layer 130, optical sensor 112 and/or display 104. In some embodiments, the relatively transmissive regions 1101 can include transparent electrodes 1105 or electronic materials 1107, such as semiconductors. In some embodiments, the relatively non-transmissive regions 1103 can include emissive pixels 1109, or emissive subpixels 1111.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent embodiments can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical system, comprising:
an image sensor;
a plurality of microlenses, at least one microlens of the plurality of microlenses defining a microlens height and a microlens diameter;
a plurality of light-blocking structures, at least one light-blocking structure of the plurality of light-blocking structures defining a light-blocking structure height and a light-blocking structure width; and
an aperture array defining a plurality of apertures, at least one aperture being aligned with a microlens of the plurality of microlenses;
wherein the microlenses and the light-blocking structures extend from one of the aperture array toward the image sensor and the aperture array away from the image sensor.

2. The optical system of claim 1, wherein a distal surface of the light-blocking member includes a light blocking material.

3. The optical system of claim 1, wherein a side surface of the light-blocking member includes a light blocking material.

4. The optical system of claim 1, wherein the at least one light-blocking structure of the plurality of light-blocking structures defines a cavity therein.

5. The optical system of claim 1, wherein a land is disposed between two successive microlenses of the plurality of microlenses and a light-blocking structure is disposed between another two successive microlenses of the plurality of microlenses.

6. The optical system of claim 1, wherein a light-blocking structure and two gaps are disposed between two successive microlenses, a first gap being disposed substantially between the light blocking structure and a first microlens of the two successive microlenses and a second gap being disposed substantially between the light blocking structure and a second microlens of the two successive microlenses.

7. The optical system of claim 1, wherein the light-blocking structure height is greater than the microlens height.

8. The optical system of claim 1, wherein the light-blocking structure height is greater than the microlens diameter.

9. The optical system of claim 1, wherein the light-blocking structure height is greater than the light-blocking structure width.

10. The optical system of claim 1, wherein the light-blocking structure height is less than the microlens height.

11. The optical system of claim 1, wherein the light-blocking structure height is less than the microlens diameter.

12. The optical system of claim 1, wherein the light-blocking structure height is less than the light-blocking structure width.

13. The optical system of claim 1, wherein the light-blocking structure height is less than the length of a gap disposed adjacent the light-blocking structure.

14. The optical system of claim 1, wherein the light-blocking structure height is greater than the length of a gap disposed adjacent the light-blocking structure.

15. An optical system, comprising:
a display;
a plurality of microlenses, at least one microlens of the plurality of microlenses defining a microlens height and a microlens diameter;
a plurality of light-blocking structures, at least one light-blocking structure of the plurality of light-blocking structures defining a light-blocking structure height and a light-blocking structure width; and
an aperture array defining a plurality of apertures, at least one aperture being aligned with a microlens of the plurality of microlenses;
wherein the display includes relatively transmissive regions and relatively non-transmissive regions, at least one relatively transmissive region being substantially aligned with at least one microlens and at least one relatively non-transmissive region being aligned with at least one blocking structure.
